(19) United States
(12) Patent Application Publication
(10) Pub. No.: US 2006/0055078 A1
(43) Pub. Date: Mar. 16, 2006

(54) Wetting device and spinning installation comprising a wetting device

(76) Inventors: Stefan Zikeli, Regau (AT); Friedrich Ecker, Timelkam (AT)

Correspondence Address: MICHAEL BEST & FRIEDRICH, LLP, 100 E WISCONSIN AVENUE, MILWAUKEE, WI, 53202, US

(21) Appl. No.: 10/515,880

(22) PCT Filed: Mar. 20, 2003
(86) PCT No.: PCT/EP03/02946

§ 371 Date: May 16, 2005

(30) Foreign Application Priority Data
May 24, 2002 (DE) 102 23 268.7

(51) Int. Cl. D01F 2/02; D01F 6/04; B29C 47/88

(52) U.S. Cl. 264/211.14; 264/187; 264/203

(57) ABSTRACT

The invention relates to a wetting device (9) for installation in a spinning system (1) for the manufacture of spinning threads (6) from a spinning solution containing water, cellulose and tertiary amine oxide, a retrofitting kit with such a wetting device and a spinning system fitted with such a wetting device. The wetting device is provided with a supply line (13) for a treatment medium (8). The wetting devices known from the state of the art are designed as containers with a bath for the treatment medium or as overflow containers. These designs have the disadvantage that the efficiency of the spinning process due to the dipping process of the spinning threads in the treatment medium is limited and a large quantity of treatment medium must be circulated. To avoid these disadvantages, according to the invention the wetting device (9) is arranged in the installed state between the spinning threads (6) and the supply line (13) and a guide wall (12) with a wetting region (14) permeable at least in sections to the treatment medium. The spinning threads (6) can be passed along the wetting region in the installed state of the wetting device and wetted by the treatment medium.

The invention relates to a wetting device for installation in a spinning system for the manufacture of spinning threads from a spinning solution containing water, cellulose and tertiary amine oxide, with a supply line for a treatment medium and a spinning system with such a wetting device.

With spinning systems with which spinning threads are manufactured from a spinning solution containing water, cellulose and tertiary amine oxide according to the Lyocell process, the manufacture essentially occurs in the three process stages of extrusion, drawing and precipitation.

With the Lyocell process the spinning solution is passed through a field of extrusion openings and extruded to form spinning threads. Directly following the extrusion openings there is a gas section, usually in the form of an air gap in which the freshly extruded spinning threads are drawn, which leads to molecule alignment, compaction of the spinning threads and a desired thread diameter. With some processes the spinning threads are blown in the air gap with a gas to cool their surface and for compaction and to reduce the surface adhesion. Due to the reduced surface adhesion, the spinning threads no longer tend to cling together and the susceptibility of the spinning process to faults is reduced. The spinning reliability is increased correspondingly.

For precipitation, the extruded spinning solution—already in the form of spinning threads—is passed through a treatment medium such as water which precipitates the cellulose. Under the effect of the treatment medium the spinning threads coagulate and harden.

With many spinning systems known from the state of the art, the treatment medium is accommodated in a spinning bath container through which the spinning threads are passed. These types of devices are for example known from WO 96/20300 and DE 100 37 923. If extrusion openings are arranged on a circular ring surface or a circular surface, then the spinning bath containers can also be formed as funnels as with the devices of WO 94/28218, DE 44 09 609 and WO 01/68958.

The spinning bath containers used in the state of the art lead to spinning systems which are easy to operate from a process standpoint, but they have a decisive limitation on the efficiency of the process which is essentially determined by the extrusion speed of the spinning solution and the transport speed of the spinning threads through the treatment medium and the spinning density, i.e. the number of extrusion openings per unit area. A problem with conventional spinning bath containers is primarily the stage of dipping the spinning threads into the treatment medium: With increasing spinning speed, turbulence and currents occur increasingly due to the treatment medium that is taken up with the spinning threads. These disturbances lead to a churned up surface and therefore to mechanical stress on the spinning threads during dipping. With severe mechanical stressing the spinning threads can break, leading to an interruption in the complete manufacturing process. In addition, due to the churned up surface of the treatment medium the risk increases that the spinning threads will touch and adhere to one another, which impairs the quality of the spun threads and fibres. Consequently, with the use of spinning bath containers the extrusion speed and transport speed of the spinning threads and therefore the efficiency are subject to close limits.

With spinning funnel systems the spinning threads are passed through a funnel which is filled with a treatment medium. At the lower end of the spinning funnel the spinning threads exit through an exit opening, whereby unavoidably part of the treatment medium flows out. With spinning funnel systems close limits are also set on the spinning performance and to render the spinning process more efficient the number of spinning threads passed through the spinning funnel must be increased. The consequence of this is that the spinning funnel must be extended and the exit opening must be enlarged. Due to the lengthened spinning funnel the static pressure in the treatment medium at the exit opening increases, leading to high outflow speeds at the exit opening. Due to the additionally enlarged diameter of the exit opening, disproportionately more treatment medium flows out, the turbulence in the spinning funnel becomes more pronounced and more treatment medium must be recirculated.

In the prior art there are therefore solutions in which alternatives to spinning bath containers are sought.

For example, with the devices of WO 96/30566 and JP 59-228012 the spinning threads are passed through a film of treatment medium which trickles down along a sloping surface of a spinning bath container formed as an overflow container.

With the device of U.S. Pat. No. 4,869,860 a type of waterfall is produced by an overflow container with the treatment medium through which the spinning threads are passed.

Although with these devices the problems typically found with spinning bath containers during dipping the spinning threads into the treatment medium appear to be avoided, the consumption and the recirculation amount of treatment medium is uneconomically high as it was previously the case. In addition, also with these solutions the achievable spinning speed with acceptable spinning reliability is too low for present-day requirements.

The object of the invention is therefore to improve the known spinning systems such that the efficiency of the process is improved by increasing the spinning speed and reducing the required treatment medium while improving control of the precipitation process.

This object is solved for a wetting device described at the beginning by a wetting region, which is arranged in the installed state of the wetting device between spinning threads and the supply line on a guide wall and which is at least in sections permeable to the treatment medium and along which the spinning threads can pass in the installed state and through which the spinning threads can be wetted with the treatment medium.

In this respect the wetting device according to the invention can also be used as a retrofit kit on existing spinning systems.

The solution according to the invention then involves passing the treatment medium through the guide wall to the spinning threads. Through this actually quite simple solution does not only good wetting of the spinning threads with the treatment medium occur, but also, compared to known wetting devices, surprisingly substantially reduced friction occurs between the spinning threads and the guide wall, because the treatment medium is pressed between the spinning threads and the guide wall and a sliding layer which reduces friction is formed between the spinning threads and the guide wall. Due to this sliding layer, the mechanical stress on the spinning, threads and the fault susceptibility of the spinning process is reduced. On account of the reduced friction the transport speed of the spinning threads can be increased without impairing the spinning reliability.

In order to simplify the formation of the sliding layer between the spinning threads and the guide wall, according to an advantageous embodiment of the invention, the guide wall can form at least in the wetting region micro-pockets on which the treatment medium carried along with the spinning threads during operation can accumulate between the spinning threads and the wetting region, so that the sliding layer becomes thicker. These micro-pockets can be formed in the shape of longitudinal grooves which extend transversally to the transport direction of the spinning threads or in the shape of regularly or irregularly arranged indentations similar to the surface of a golf ball. A net or grid type surface structure also facilitates the formation of a sliding layer.

The supply line for the treatment medium to the wetting region is then especially simple in design if the guide wall is formed on an essentially hollow cylindrical body through which the treatment medium can be passed to the wetting region in operation. With this advantageous embodiment the guide wall is part of the supply line of the treatment medium. In particular, according to an advantageous development, the hollow cylindrical body can be essentially roller-shaped.

According to another advantageous embodiment, the wetting device can exhibit at least one bearing through which the body forming the guide wall can be fitted rotationally to the spinning system. Through this embodiment the situation can be achieved in which the guide wall rotates with the spinning threads so that the friction between spinning threads and guide wall is further reduced.

With a rotatable guide wall it is also of advantage if the guide wall is formed along a body which is essentially rotationally symmetrical. The regions permeable to the treatment medium can extend over the whole circumference or can be subdivided into spaced out regions in the circumferential direction.

According to another advantageous embodiment, a controlled friction resistance can be adjusted between the spinning threads and guide wall, giving a controlled tensile stress in the spinning threads, by control of the guide wall movement relative to the movement of the spinning threads. In this respect, the wetting device can exhibit a rotational means through which the rotational movement of the guide wall can be influenced. Such a means of rotation can be, for example, a motor, for example, an electric motor or a brake. With a motor the guide wall can be driven in the direction of the spinning threads or against the direction of the spinning threads, so that the wetting device also acts as a drawing means, through which a tensile force can be applied upstream to the spinning threads, for example with rotation of the guide wall with a greater speed than the transport speed of the spinning threads—or downstream—for example with rotation with a speed lower than or opposite to the transport speed of the spinning threads.

As materials for the guide wall, porous materials can be considered which are based on composites of a number of layers of materials of different porosity. These types of porous materials can be sinter materials or materials formed from textiles, knitted fabrics or fleeces.

Irrespective of the embodiment as a drawing means, the wetting device according to the invention can also be used as a diversion unit through which the transport direction of the spinning threads is changed. In this respect, the wetting surface can be formed curved especially in the transport direction of the spinning threads.

With spinning systems which are fitted with a wetting device according to the invention also a number of wetting devices, at least two, can be arranged one behind the other in the transport direction of the spinning threads.

By cascading a number of wetting stages one behind the other, a specific and conserving coagulation of the spinning threads can be achieved over a number of stages. This partial precipitation on each treatment device can be further positively influenced in that a different treatment medium, for example treatment media with different concentrations, can be fed to each wetting device.

Alternatively, the cascaded wetting devices can in an advantageous development also be supplied consecutively with the treatment medium.

If the wetting device is also used as a drawing means or drawing-off means, then especially many wetting devices can be arranged cascaded with rotationally supported bodies forming the guide wall. In this manner, not only a multistage precipitation can be achieved, but also a multistage drawing.

Alternatively, a wetting device can also alternate with a rotationally supported body and a wetting device with a fixed guide wall. In this case the tensile stress in the spinning threads and therefore the degree of drawing is produced by the rotational speed of the rotationally supported body and by the frictional resistance of the spinning threads on the stationary guide wall.

Through the wetting device according to the invention the mechanical properties of the spinning threads can in this manner be decisively improved compared to conventional wetting devices without the spinning speed having to be reduced and consequently impairing the efficiency of the spinning thread manufacture. In addition, the wetting device according to the invention which is used instead of a spinning bath container can be more flexibly employed and can also be used as a diversion unit and/or as a drawing means.

The advantages according to the invention are also achieved by using an appropriate process flow.

In the following the structure and function of the solution according to the invention is explained based on various embodiments as examples with reference to the drawings. In this respect, the various features of the individual embodiments can be combined with one another as required without having to restrict the application of a feature described with a particular version exactly to this embodiment.

The following are shown:

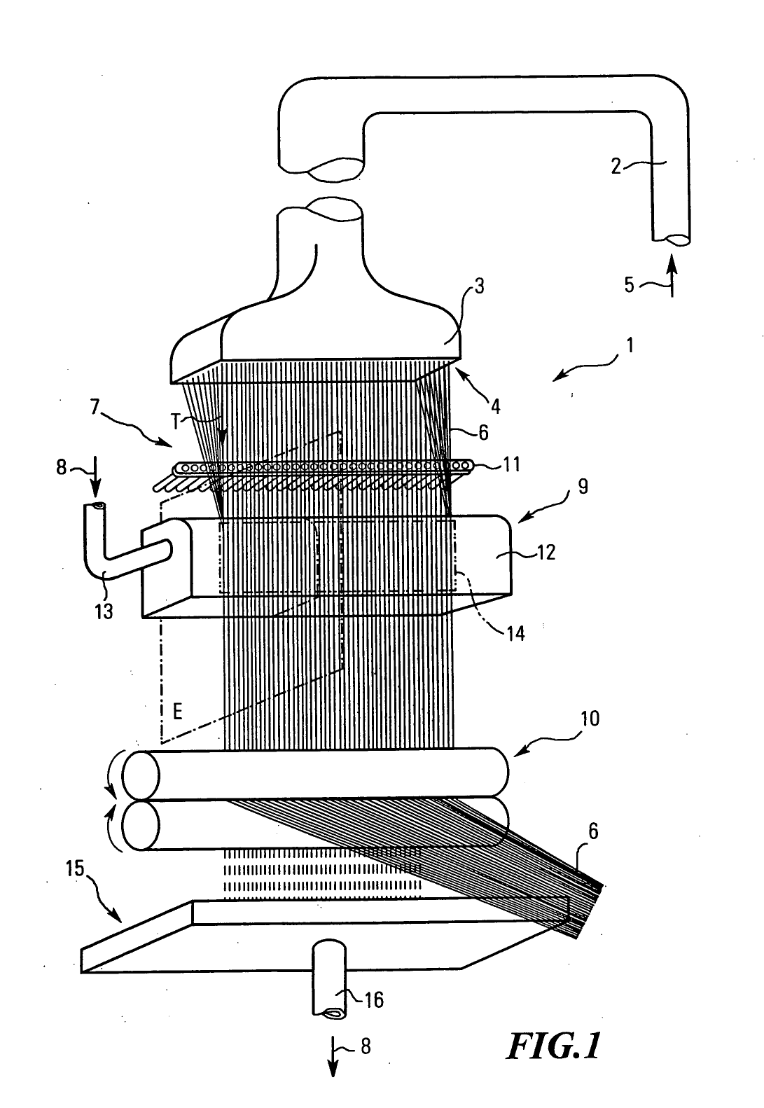

FIG. 1 shows a schematic illustration of a spinning system with an embodiment of a wetting device according to the invention;

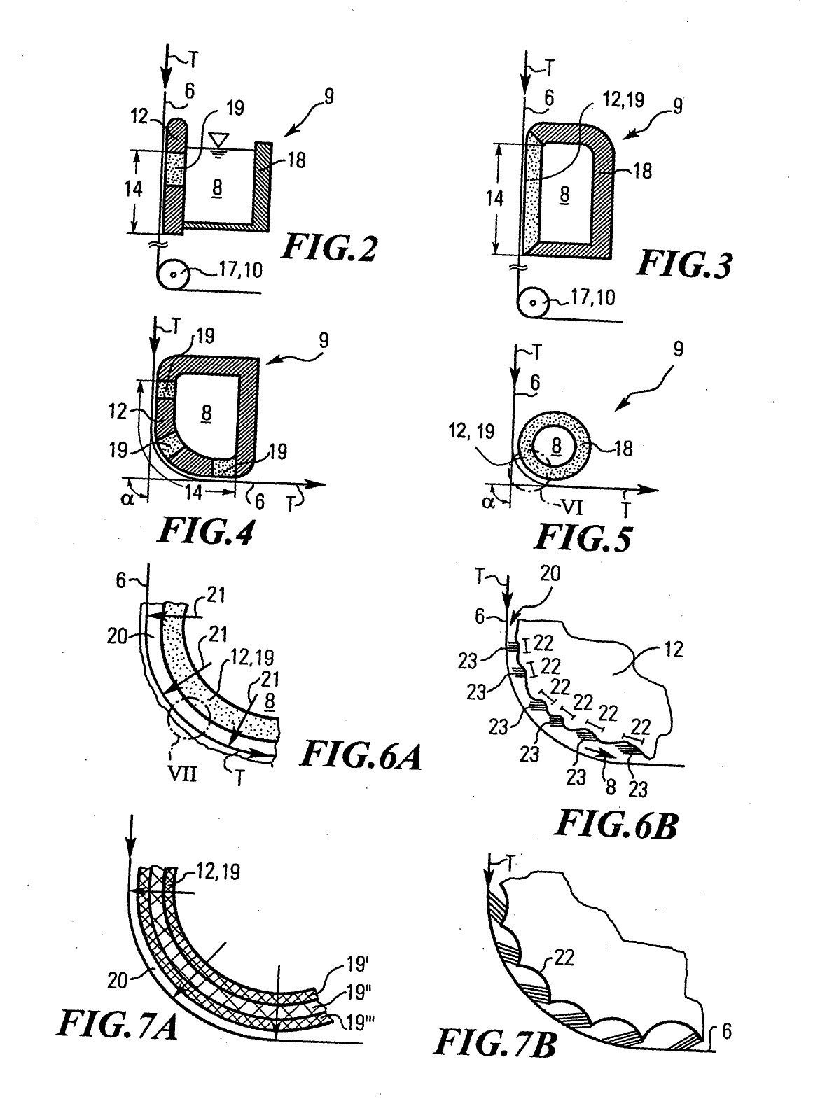

FIGS. 2 to 5 show further embodiments of wetting devices according to the invention in cross-section along the plane E of FIG. 1;

FIGS. 6A and 7A show schematic detailed illustrations of the detail VI of FIG. 5 of two further embodiments of the wetting device according to the invention;

FIGS. 6B and 7B show detailed illustrations of the detail VII of FIG. 6A of two further embodiments of the wetting device according to the invention;

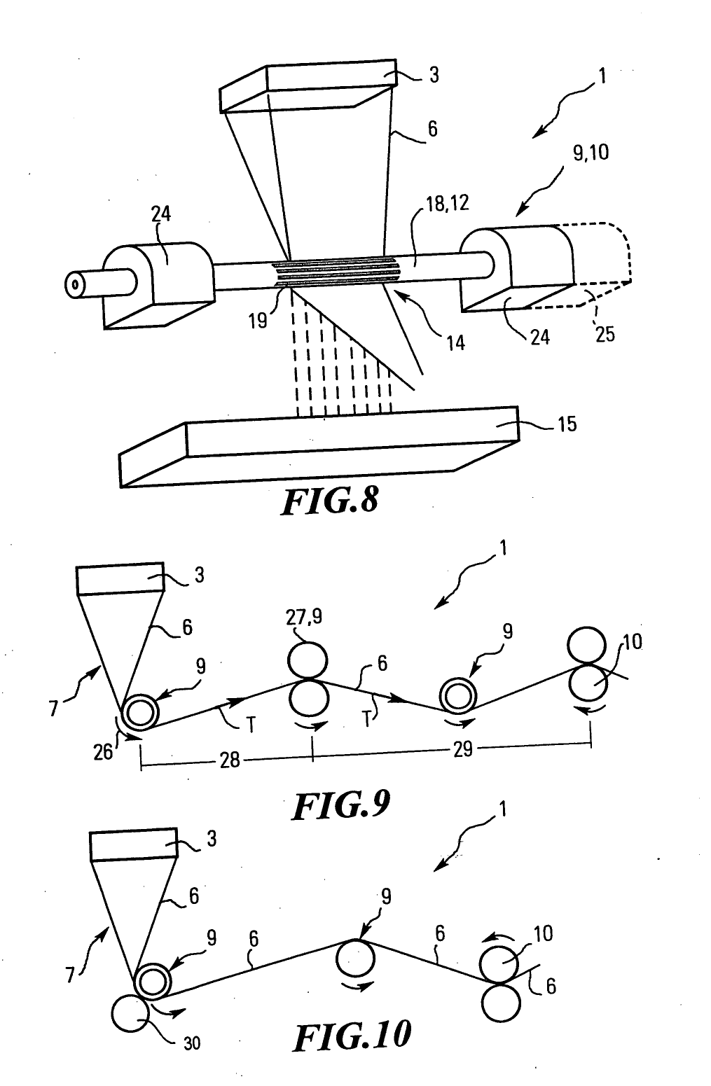

FIG. 8 shows a schematic illustration of a spinning system of a further embodiment of a wetting device according to the invention;

FIGS. 9 to 11 show schematic illustrations of possible process flow using the wetting devices according to the invention.

FIG. 1 shows a spinning system 1 through which a spinning solution 5 is extruded to spinning threads 6, said solution being passed through a heated pipe system 2 to an extrusion head 3 with a large number of extrusion openings 4-arranged on a rectangular surface. With the spinning system 1 of FIG. 1 the spinning threads 6 are manufactured according to the Lyocell process from a spinning solution containing water, cellulose and tertiary amine oxide.

Through the spinning system 1 the three process stages typical for the Lyocell process are carried out, that is the extrusion of the spinning solution 5 to spinning threads 6, the following drawing of the extruded spinning threads 6 in a gas section 7 and the wetting of the drawn spinning threads 6 with a treatment medium such as water for the precipitation and compaction of the spinning threads.

The drawing of the spinning threads 6 in the gas section 7 can take place in a non-mechanical manner for example through air which axially flows around the spinning threads, the speed of the air being faster than the transport speed T of the spinning threads 6 or in a mechanical manner by a drawing-off mechanism 10 through which the spinning threads are drawn off. The drawing-off mechanism 10 can exhibit motor-driven rollers.

If a mechanical drawing-off mechanism, as shown in FIG. 1, is used, a blowing of the spinning threads 6 can take place in the gas section 7 essentially transverse to the transport direction T of the spinning threads. In this respect, a blowing device 11 is used which preferably directs a turbulent gas flow over the spinning threads 6.

The wetting of the drawn spinning threads 6 with wetting fluid 8 can, as shown in FIG. 1, take place through a wetting device 9 according to the invention in which a guide wall 12 is arranged between a supply line 13, through which the treatment medium 8 is passed to the wetting device 9, and the spinning threads 6. On the guide wall 12, along which the spinning threads 6 are passed in the transport direction T in the form of an essentially plane curtain, a wetting region 14 is provided which is illustrated in FIG. 1 with a double-dotted dashed-dotted line. The wetting region 14 is at least in sections permeable to the treatment medium so that treatment medium 8 brought by the supply line 13 is emitted from the guide wall 12 in the wetting region 14 and wets the spinning threads 6 passed along the guide wall. The treatment medium 8 is pressed out of the spinning threads 6 by the drawing-off mechanism 10, so that it drops or flows into a catchment receptacle 15. The treatment medium 8 is passed from the catchment receptacle 15 via drain pipes 16 to reprocessing stages which are not shown in FIG. 1. After reprocessing the used treatment medium 8 can be passed again to the wetting device 9.

The embodiment of a wetting device 9 according to the invention shown as an example in FIG. 1 is used instead of the spinning bath containers and replaces them completely. In operation the spinning threads 6 are located in the wetting region 14 on the guide wall 12, whereby a sliding film of treatment medium 8 is situated preferably between the spinning threads and the wetting region 14.

With the following description of other embodiments of the wetting device 9 the same reference symbols are used for components, the construction or/and function of which corresponds to the construction or/and function of components in FIG. 1.

First, other embodiments of the body incorporating the guide wall 12 are described with reference to FIGS. 2 to 5. The embodiments of FIGS. 2 to 5 are illustrated in a cross-section along the plane E of FIG. 1.

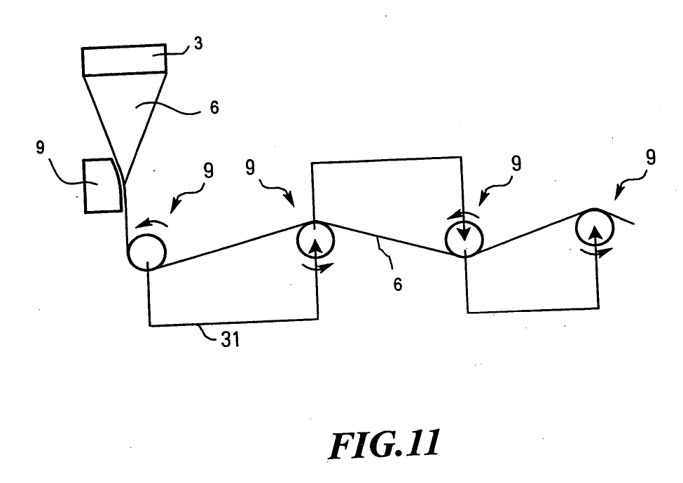

With the embodiments in FIGS. 2 and 3 the guide wall 12 which forms the wetting region 14 is formed essentially as a plane or/and as a wall which is slightly curved perpendicular to the plane of drawing. A diversion of the transport direction T of the spinning threads 6 occurs therefore with the wetting devices 9 in FIGS. 2 and 3 due to a following arranged diversion unit 17 or due to the known drawing-off mechanism 10 from FIG. 10.

With the embodiment of FIG. 2 the body 18 forming the guide wall 12 is formed as an open channel filled with treatment fluid. Solely due to the static pressure. of the treatment medium 8, it is pressed onto the side of the spinning threads 6 through a region 19 of the wetting region 14 which is permeable to the treatment medium, the spinning threads 6 being wetted by the treatment medium. The region 19 can incorporate the whole wetting region 14 or only parts of it. With the embodiment in FIG. 3 the body 18 of the wetting device 9 is essentially formed as a hollow cylinder, whereby the treatment medium 8 is guided inside the hollow cylindrical body 18. With this enclosed version of the body 18 the treatment medium 8 can be placed under pressure, so that a controllable quantity of treatment medium 8 is pressed through the porous region of the wetting region 14. In contrast to the embodiment of FIG. 2, with the embodiment of FIG. 3 the complete wetting region 14 is formed permeable for the treatment medium. Since the guide wall 12 is essentially straight in the transport direction T of the spinning threads also with the embodiment of FIG. 3, diversion of the spinning threads by a following diversion unit 17 or a following drawing-off mechanism 10 must occur.

A following diversion unit 17 can be omitted if the guide wall 12 is curved in the transport direction T of the spinning threads 6. Depending on the curvature and length of the guide wall 12 any diversion angle α can be obtained. The diversion angle α is mainly given by the degree to which the spinning threads 6 twine round the body 18.

With the embodiment of FIG. 4 the straight guide wall 12 according to the embodiment of FIG. 3 is replaced by a guide wall 12 curved in the transport direction T. In contrast to the embodiment of FIG. 3 a number of regions 19, separated from one another and permeable to the treatment medium, are provided in the wetting region 14, preferably at the points at which a high contact pressure of the spinning threads on the guide wall 12 prevails due to the diversion of the spinning threads 6 by the diversion angle α. Strong friction between the spinning threads 6 and the guide wall 12 is avoided in these critical regions with this embodiment due to the treatment medium which is emitted in these regions under pressure.

A further embodiment of a wetting device 9 according to the invention, which also functions as a diversion unit, is illustrated in FIG. 5. The body 18 of this embodiment is also hollow and cylindrical, especially formed as a pipe with, at least in the wetting region 14, a permeable wall, passable to the treatment medium. The inner space of the pipe-shaped body 18 contains treatment medium 8. With this embodiment the treatment medium is emitted over the complete circumference of the body 18.

Due to the double function as wetting device and as diversion unit the process flow and the construction of spinning systems is substantially simplified. Compared to conventional diversion devices there is the advantage that, due to the treatment medium passed through the guide wall 12, the treatment medium accumulates between the spinning threads and the guide wall 12 or is pressed into this region, so that a sliding layer forms which reduces the friction of the spinning threads. On account of the reduced friction the diversion of the spinning threads according to the invention can take place at a significantly earlier point in time after the extrusion of the spinning solution compared to the prior art at which the spinning threads are not completely coagulated. Also, a larger diversion angle α can be obtained.

The formation of a sliding layer 20 between the spinning threads 6 and the guide wall 12 is illustrated schematically in FIG. 6A which shows the enlarged detail VI of FIG. 5. The treatment medium 8 which is under pressure is pressed along the arrows 21 through the regions 18 of the guide wall 12 that are permeable to the treatment medium in the wetting region 14 between the spinning threads 6 and the guide wall 12. Since the spinning threads are transported as a dense, plane curtain past the guide wall 12, they represent a substantial resistance against the flow of the treatment medium. Consequently, only a slight part of the treatment medium 8 is emitted through the spinning threads 6; the larger part of the treatment medium is carried along with the spinning threads 6 with the formation of the sliding layer 20.

FIG. 6A just shows as an example that the region 19 of the guide wall 12, permeable for the treatment medium, is constructed uniformly over the complete material thickness.

As shown in the embodiment of FIG. 7B, where the detail VI of FIG. 5 is also shown enlarged, the guide wall 12 can also exhibit a multilayer structure. In particular, the region 19 permeable to the treatment medium can be constructed from many permeable layers 19′, 19″, 19″′, . . . These individual layers can be variously constructed, for example once as a textile or knitted fabric layer, another one as a fleece layer and with different permeabilities. Also, various sinter layers or a single-part structure are possible from a sintered guide wall 12.

The formation of the sliding layer 20 can be facilitated by various measures. Examples of such measures are illustrated in FIGS. 6B and 7B in which the detail VII of FIG. 6A is shown enlarged.

With the embodiment illustrated in FIG. 6B the formation of a sliding layer 20 is simplified in that the guide wall 12 forms, in the wetting region, micro-pockets 22 to which the treatment medium 8 that is carried along by the transport movement T of the spinning threads 6 accumulates in the regions 23 shown hatched, thereby pressing the spinning threads, which are diverted as a curtain, away from the surface of the guide wall 12. Those regions are designated micro-pockets in which the surface compared to the surroundings is raised in the transport direction T, so that a type of indentation or “pocket” is created in front of this raised region. On these pockets the pressure in the treatment medium increases due to the accumulation. The micro-pockets can be distributed randomly or regularly over the surface of the guide wall 12 and can exhibit micro-pocket heights of between 20 and 150 μm. The micro-pockets 22 can also be formed by a net type of surface structure or, as shown in FIG. 7B, by longitudinal grooves which essentially extend transversally to the transport direction T of the spinning threads 6.

In FIG. 8 a schematic illustration similar to the illustration in FIG. 1 is shown, whereby however the wetting device 9 exhibits essentially a roll or tubular shaped body 18, which also functions as a diversion unit 10. The body 18 is held so that it can rotate in a bearing 24, illustrated schematically, on the spinning system 1, so that the guide wall 12 can exhibit a rotational speed. If the body 18 can freely rotate, then the friction can be reduced further by the rotational support.

The body 18 of the embodiment in FIG. 8 can be influenced in its rotation by an optional drive system 25, for example braked or accelerated with respect to the transport speed of the spinning threads. In this manner using this drive system 25 a tensile force can be introduced into the spinning threads 6 in the region upstream or downstream of the wetting device 9. Consequently, the wetting device 9 can also be used in a double function as a drawing means.

It is also pointed out that with the embodiment of FIG. 8 the guide wall 12 in the wetting region 14 is provided with sections 19 extending axially over the wetting region 14 and spaced from one another in the circumferential direction and which are permeable for the treatment medium 8.

With reference to FIGS. 9 to 11, advantageous process flows will be explained using the wetting device 9 according to the invention. Depending on the specific requirements, the individual features of the process guide systems of FIGS. 9 to 11 can be combined together as required and also with wetting devices with features from the embodiments in FIGS. 1 to 8.

In FIG. 9 a spinning system 1 is illustrated in which a wetting device 9 according to the invention is driven rotationally in the direction indicated by the arrow 26. The wetting device 9 is used at this point both for wetting the spinning threads and also for drawing the spinning threads in the gas section 7 directly after extrusion. At the same time the spinning threads are diverted by the wetting device 9. After wetting by the wetting device 9 the spinning threads 6 are held essentially stress free by a roller mechanism 27 rotating against the transport direction T of the spinning threads 6 in a region 28 for thorough-coagulation. A region 29 with strong drawing follows the region 28. In the region 29 a further wetting device 9 according to the invention is arranged which passively rotates with the spinning threads 6 or is driven rotationally in their direction. In the region 29 the stretching is determined by the difference in speed between the roller mechanism 27 and a drawing-off mechanism 10 arranged behind the second wetting device 9. With the process flow illustrated in FIG. 9 multi-stage precipitation and simultaneously multi-stage drawing of the spinning threads can be realised.

With the process flow in FIG. 10 the wetting device 9 immediately following the gas section 7 is again also used as a diversion unit and drawing means as well as a substitute for the spinning bath container. In FIG. 10 the wetting device 9 is provided with a further roller 30, the construction of which can correspond to one of the above described embodiments, which however can also be designed just as a conventional pressure roller. The spinning threads 6 are subjected to an initial treatment medium 8 by the wetting device 9. In a following, second wetting device 9 a second treatment medium different to the treatment medium fed in by the first wetting device 9 is applied. Up to the drawing-off mechanism 10 and the passing of the spinning threads 6 to the following treatment stages, further wetting devices 9 can be provided at which in each case different treatment media are fed in. Adapted to the different treatment media, the relevant drawing can also be matched to the individual wetting devices, as already explained in FIG. 9.

As illustrated in FIG. 11, many cascaded wetting devices 9 can also be supplied in series with the same treatment fluid through a pipe system 31. In this respect, for example, the treatment medium 8 can pass consecutively through the bodies 18 of the wetting device 9.

In the following the advantageous effect of the wetting device according to the invention is documented based on eight comparative examples. As a result of the comparative examples, the spinning characteristics of the spun spinning threads are assessed with marks between “very good” to “adequate”, whereby very good spinning characteristics imply high spinning reliability, i.e. low tendency to thread breakage and thread entanglement during the spinning process, with simultaneously good mechanical properties such as strength and fibrillation tendency. With spinning characteristics assessed as only adequate, such as with the conventional spinning process of comparative examples 1 and 5, a high susceptibility to faults is observed in the spinning process and the spinning reliability is low.

### COMPARATIVE EXAMPLE 1

With Comparative Example 1 the spinning process was carried out with the process stages known from the state of the art. The spinning system used here comprised an extrusion head with extrusion openings with a hole density of 0.25/mm² arranged over a rectangular area in five rows of holes. The zero-shear viscosity of the spinning solution was 17000 Pas with a Cellulose DP of 700 and a concentration of 13.5% cellulose, 10.5% water and 76% amine oxide. The stabiliser, gallic acid propylester, was added to the essentially alkali spinning solution for the thermal stabilisation of the cellulose and the solvent. The spun titer of the spinning threads was 1.42 dtex. After extrusion the spinning threads were passed through a gas section (air gap) with a length of 60 mm, where they were blown. After passing through the gas section the spinning threads were passed into a bath of treatment medium and then diverted by a diversion unit. The diversion angle α was 55°. The spinning threads were drawn off with a drawing-off speed of 200 m/min.

Although the strength of the spun spinning threads according to Comparative Example 1 is high, the spinning process is very susceptible to faults and the titer of the spun spinning threads exhibits a high variation of 14.5%. The spinning performance of the spinning system in the configuration according to Comparative Example 1 was therefore assessed as adequate.

### COMPARATIVE EXAMPLE 2

With Comparative Example 2 the bath of treatment medium was replaced by a wetting device according to the invention which also acted as a diversion unit. The body 18 of the wetting device here consisted of a tubular filter of stainless steel with a porosity, i.e. a mean pore or opening size, of 2 μm.

With the process parameters essentially unchanged as in Comparative Example 1, with Comparative Example 2 the drawing-off speed was able to be increased to 650 m/min using the wetting device according to the invention and, however, a very good peak performance was achieved. The fault susceptibility of the spinning process was low and the titer also exhibited a low distribution.

### COMPARATIVE EXAMPLE 3

With Comparative Example 3 an extrusion head with just one row of holes was used. Also, in contrast to Comparative Examples 1 and 2, blowing in the gas section was omitted and the gas section was shortened to 50 mm and the spinning speed set to 350 m/min.

Instead of a bath of treatment medium again a wetting device according to the invention was used which also acted as a diversion unit with a diversion angle of 65°. The body of the wetting device was a tubular filter of polyethylene with a porosity of 20 μm.

Also with this test configuration a very good spinning performance was obtained with very low fault susceptibility. Although blowing in the air gap was omitted and the air gap was reduced, as with Comparative Examples 1 and 2, a low distribution of the titer was achieved.

### COMPARATIVE EXAMPLE 4

With Comparative Example 4 again a wetting device according to the invention was used, whereby the body 18 of the wetting device with a hose diaphragm with a porosity of 0.2 μm was used.

Compared to Comparative Examples 1 to 3, in Comparative Example 4 the diversion angle was increased to 165°. Due to this increase, the drawing-off speed had to be reduced slightly to 250 m/min.

Despite this extremely high diversion angle and despite the high drawing-off speed, a good spinning performance was achieved and the fault susceptibility of the spinning process was very low.

### COMPARATIVE EXAMPLE 5

With Comparative Example 5 a spinning system known from the state of the art was used with a hole density increased tenfold compared to Comparative Examples 1 to 4 and with 32 rows of holes. The length of the air gap passed by the spinning threads after extrusion was reduced to 22 mm, whereby blowing occurred in the air gap. The drawing-off speed was reduced to 60 m/min due to the high spinning density.

Also here, only an adequate spinning performance was obtained, because the spinning process had to be interrupted sometimes due to thread breakages and entanglement, caused by the significantly increased bath turbulences due to the increased spinning bath speed.

### COMPARATIVE EXAMPLE 6

With Comparative Example 6 the bath of treatment medium was replaced by a wetting device according to the invention which also served as a diversion unit. A tubular filter of stainless steel with a porosity of 2 μm was used as the body 18.

The drawing-off speed was increased compared to Comparative Example 5 to 70 m/min.

In this configuration a substantially improved spinning performance was achieved compared to Comparative Example 5 with a substantially reduced fault susceptibility.

### COMPARATIVE EXAMPLES 7 and 8

In these two comparative examples a two-stage precipitation was carried out by two wetting devices according to the invention cascaded in the transport direction of the spinning threads.

In the two cascaded wetting devices a tubular filter of stainless steel with a porosity of 2 μm was used.

The treatment medium fed to the first wetting device in Comparative Examples 7 and 8 exhibited a spinning bath concentration of 50% and in the following, second wetting device the spinning bath concentration in the treatment medium fed to it was reduced to 20%.

The diversion angle in the first wetting device in the Comparative Examples 7 and 8 was 55° and in the second wetting device 170°.

Compared to Comparative Example 7 the drawing ratio of the second stage to the first stage was increased with Comparative Example 8, i.e. in the second stage of Comparative Example 8 higher drawing occurred.

Both in Comparative Example 7 and Comparative Example 8 a very good spinning performance was observed with a very low fault susceptibility. The strength was high and the titer exhibited very low variation.

From the results of the comparative examples it can be established that by using the wetting device according to the invention to substitute the bath for the treatment medium, a high efficiency through lower consumption of treatment medium is possible with at the same time improved spinning performance without blowing in the air gap. At the same time, the wetting device according to the invention facilitates a substantially improved variability of the process guide system than the devices known from the state of the art.

The results of the test examples are summarised in the following table:

| Example | | 1 | 2 | 3 | 4 | 5 | 6 | 7 | 8 |
|---|---|---|---|---|---|---|---|---|---|
| Titer | dtex | 1.37 | 1.45 | 1.41 | 1.36 | 1.38 | 1.38 | 1.32 | 1.35 |
| Take-off | m/min | 200 | 650 | 350 | 250 | 60 | 70 | 250 | 250 |
| speed | | | | | | | | | |
| Zero-shear | Pas | 17000 | 17000 | 16000 | 16000 | 17000 | 17000 | 18000 | 18000 |
| viscosity | | | | | | | | | |
| Hole density | 1/mm² | 0.25 | 0.25 | 0.25 | 0.25 | 2.5 | 2.5 | 0.25 | 0.25 |
| Rows of | — | 5 | 5 | 1 | 1 | 32 | 32 | 5 | 5 |
| holes | | | | | | | | | |
| Airgap | mm | 60 | 60 | 50 | 40 | 22 | 22 | 40 | 40 |
| Blowing | — | Yes | Yes | No | No | Yes | Yes | Yes | Yes |

Stage 1

| | | Spinning | Tubular | | | Spinning | Tubular filter | Tubular | Tubular |
|---|---|---|---|---|---|---|---|---|---|
| | | bath tank | filter stain- | Tubular filter | Hose dia- | bath tank | stainless | filter stain- | filter stain- |
| Diversion unit | | diverter | less steel | PE porous | phragm | diverter | steel | less steel | less steel |
| Fineness | μ | | 2 | 20 | 0.2 | | 2 | 2 | 2 |
| Diversion | | 55 | 55 | 65 | 165 | 65 | 65 | 55 | 55 |
| angle - alpha | | | | | | | | | |
| Spinning bath | % | 10 | 8 | 12 | 7 | 20 | 20 | 50 | 50 |
| concentration | | | | | | | | | |
| Spinning bath | ° C. | 25 | 25 | 28 | 26 | 18 | 18 | 25 | 25 |
| temp. | | | | | | | | | |
| Amount per | l/h | | | | | | | | |
| cm diversion | | | | | | | | | |
| width | | | | | | | | | |

Stage 2

| | | | | | | | | Tubular | Tubular |
|---|---|---|---|---|---|---|---|---|---|
| Diversion | | | | | | | | filter stain- | filter stain- |
| unit | | | | | | | | less steel | less steel |
| Fineness | μ | | | | | | | 2 | 2 |
| Diversion | 170 | 170 | | | | | | | |
| angle | | | | | | | | | |
| Spinning bath | % | 20 | 20 | | | | | | |
| concentration | | | | | | | | | |
| Spinning bath | *C | 25 | 20 | | | | | | |
| temp. | | | | | | | | | |
| Amount per | l/h | | | | | | | | |
| cm diversion | | | | | | | | | |
| width | | | | | | | | | |
| Draw ratio | | 1.04 | 1.04 | 1.04 | 1.04 | 0.96 | 0.96 | 1.3 | 1.8 |
| stage 2 | | | | | | | | | |
| (d2/d1) | | | | | | | | | |

Results

| Spinning | | | | | | | | | |
|---|---|---|---|---|---|---|---|---|---|
| performance | | adequate | very good | very good | good | adequate | very good | very good | very good |
| Strength | cN/ | 40.1 | 39.2 | 40.5 | 39 | 38.8 | 40.5 | 42 | 40.5 |
| | tex | | | | | | | | |
| Strain | % | 10.9 | 11.3 | 11.1 | 11.6 | 12.1 | 12.9 | 11.1 | 10.2 |
| cV titer | % | 14.5 | 12.7 | 10.2 | 13.1 | 10.2 | 9.6 | 12.1 | 13.4 |

1. A wetting device for installation into a spinning system for the manufacture of spinning threads with a supply line for a treatment medium, comprising wetting region arranged in the installed state on a guide wall between the spinning threads and the supply line, permeable to the treatment medium at least in sections and along which the spinning threads can, in the installed state, be passed and through which the spinning thread can be wetted with the treatment medium.

2. Wetting device according to claim 1, wherein the guide wall forms micro-pockets at least in the wetting region, the treatment medium being able to accumulate on the said micro-pockets in operation between the spinning threads and the wetting region for the formation of a sliding layer.

3. Wetting device (according to claim 1, wherein the guide wall is formed on an essentially hollow cylindrical body through which the treatment medium can be fed during operation.

4. Wetting device according to claim 3, wherein the hollow cylindrical body is essentially formed roller-shaped.

5. Wetting device according to claim 1, wherein the wetting device exhibits at least one bearing through which the wetting device can be fitted rotationally to the spinning system.

6. Wetting device according to claim 1, wherein the wetting device exhibits a means of rotation through which a rotational movement of the body relative to the transport speed of the spinning threads can be influenced.

7. Wetting device according to claim 6, wherein the means of rotation comprises a motor.

8. Wetting device according to claim 6, wherein the means of rotation comprise a brake.

9. Wetting device according to claim 1, wherein the guide wall is porous at least in sections.

10. Wetting device according to claim 9, wherein the porous section(s) of the guide wall are formed from a plurality layers of materials of different porosity.

11. Wetting device according to claim 1, wherein the wetting region is formed curved in the transport direction (T).

12. Spinning system according to claim 1, for the manufacture of spinning threads from a spinning solution containing water, cellulose and tertiary amine oxide, through which in operation the spinning threads can be extruded from the spinning solution in a gas section, and the spinning system is provided with at least one wetting device.

13. Spinning system according to claim 12, wherein several wetting devices are arranged cascaded in the transport direction (T) of the spinning threads.

14. Spinning system according to claim 13, wherein the cascaded wetting devices are each supplied with different treatment media.

15. Spinning system according to claim 13, wherein the wetting devices are supplied consecutively with the treatment medium.

16. Spinning system according to claim 12, wherein the wetting device is also formed as a diversion device through which the spinning threads can be diverted through the guide wall in operation.

17. Spinning system according to claim 12, wherein at least one wetting device exhibits a rotationally supported body.

18. Process for the manufacture of spinning threads from a spinning solution containing water, cellulose and tertiary amine oxide, the process comprising:
extruding the spinning solution in a gas section to form spinning threads,
passing the spinning threads through the gas section,
passing the spinning threads along a wetting region and simultaneously passing treatment medium through the wetting region and wetting of the spinning threads with the treatment medium.

19. Process according to claim 18, further comprising:
diverting the spinning threads by the guide wall.

20. Process according to claim 18, further comprising:
multi-stage precipitation of the cellulose by several consecutive wetting regions.

21. Process according to claim 18, further comprising:
passing the spinning threads along a number of wetting regions which are supplied with different treatment media.

22. Process according to claim 18, further comprising:
drawing of the spinning threads by moving the wetting region.

23. Process according to claim 22, further comprising:
multi-stage drawing of the spinning threads by several consecutively arranged, moving wetting regions.

24. Process according to claim 22, whereby the wetting regions are rotationally driven or/and braked by a means of rotation.

25. Process according to claim 22, whereby the speed components of wetting regions (arranged consecutively are of different magnitude in the transport direction (T).

26. Wetting device according to claim 1, wherein the spinning threads are from a spinning solution containing water, cellulose and tertiary amine oxide.
